(19) United States
(12) Patent Application Publication
(10) Pub. No.: US 2008/0270847 A1
(43) Pub. Date: Oct. 30, 2008

(54) Methods and Apparatus for Displaying Production and Debug Test Data

(76) Inventors: Carli Connally, Fort Collins, CO (US); Kristin Petersen, Clifton Park, NY (US)

Correspondence Address: Gregory W. Osterloth;Holland & Hart, LLP, P.O. Box 8749, Denver, CO, 80201, US

(21) Appl. No.: 11/740,769

(22) Filed: Apr. 26, 2007

(51) Int. Cl. G06F 11/00

(52) U.S. Cl. 714/46; 714/27

(57) ABSTRACT

In one embodiment, a computer automatically determines whether one or more debug indicators, each of which is associated with one or more of a plurality of test data items, indicate 1) that one or more of the test data items pertain to a production mode, or 2) that one or more of the test data items pertain to a debug mode. At least one mode selector is displayed via a graphical user interface (GUI). Upon a user selecting the production mode or the debug mode, the GUI is updated to focus on a display of production test data or debug test data. Other embodiments are also disclosed.

### BACKGROUND

When testing circuit devices such as system-on-a-chip (SOC) devices, both production tests and debug tests may be executed. As defined herein, “production tests” are those tests that are executed during the ordinary course of device testing, while “debug tests” are those tests that are executed for the purpose of extracting additional test data for the purpose of debugging a problem, or monitoring a trend, seen in one or more tested devices. Debug tests can also include tests that are used to debug the operation or effectiveness of a test itself.

Typically, the results of production tests and debug tests are co-mingled. As a result, it is often difficult for a user to determine whether any particular result is a production result or a debug result. Also, software that calculates statistics or performs other sorts of data analysis treats all of the test results the same. Thus, a statistic that is designed to track the outcome of a production test, executed on a large number of devices, could be skewed by a series of debug tests, executed on only one device.

### BRIEF DESCRIPTION OF THE DRAWINGS

Illustrative embodiments of the invention are illustrated in the drawings, in which:

FIG. 1 illustrates an exemplary computer-implemented method for displaying production and debug test data;

FIGS. 2 & 3 illustrate an exemplary graphical user interface (GUI) via which the methods shown in FIGS. 1 & 4 may be implemented; and

FIG. 4 illustrates an exemplary computer-implemented method for display production and/or debug statistics.

### DETAILED DESCRIPTION

As a preliminary manner, it is noted that, in the following description, like reference numbers appearing in different drawing figures refer to like elements/features. Often, therefore, like elements/features that appear in different drawing figures will not be described in detail with respect to each of the drawing figures.

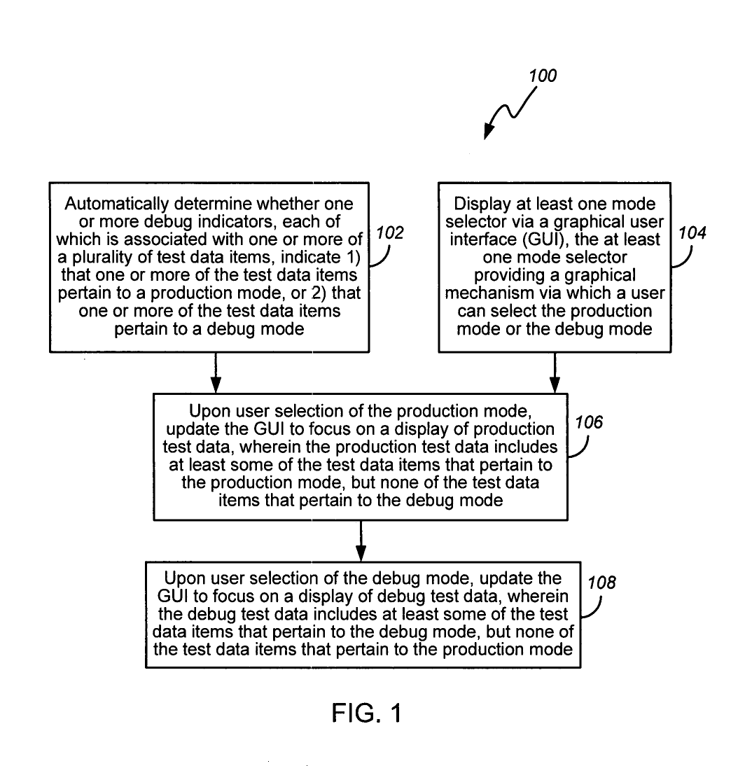

In accord with one embodiment of the invention, FIG. 1 illustrates a computer-implemented method 100 that operates on a plurality of test data items and one or more debug indicators. In one embodiment, the test data items may pertain to tests of a system-on-a-chip (SOC) device, such as tests that have been executed by the V93000 SOC tester distributed by Verigy Ltd. However, the test data items could also pertain to tests that are executed by other sorts of testers, or tests that are executed on other sorts of circuit devices. In some cases, the test data items may be provided by, or derived from, one of the data formatters disclosed in the U.S. patent application of Connally, et al. entitled “Apparatus for Storing and Formatting Data” (Ser. No. 11/345,040).

The debug indicators may also take various forms. In some cases, one or more of the debug indicators may comprise tags that are associated with individual ones of the test data items. Alternately, or additionally, one or more of the debug indicators may comprise contextual information that is interspersed with a sequential order in which the test data items are generated or received. Regardless of their form, each of the debug indicators is 1) associated with one or more of the plurality of test data items, and 2) specifies or suggests whether one or more of the test data items pertain to a production test mode or a debug test mode.

Returning to the method 100, the method begins with a computer automatically determining whether one or more of the afore-mentioned debug indicators indicate 1) that one or more of the test data items pertain to a production mode, or 2) that one or more of the test data items pertain to a debug mode. See, block 102. Before, during or after this determination, at least one mode selector is displayed via a graphical user interface (GUI). See, block 104. The at least one mode selector provides a graphical mechanism via which a user can select the production mode or the debug mode.

Upon user selection of the production mode, the method 100 updates the GUI to focus on a display of production test data. The production test data includes at least some of the test data items that pertain to the production mode, but none of the test data items that pertain to the debug mode. See, block 106. Upon user selection of the debug mode, the method 100 updates the GUI to focus on a display of debug test data. The debug test data includes at least some of the test data items that pertain to the debug mode, but none of the test data items that pertain to the production mode. See, block 108.

Of note, the steps of the method 100 may take orders other than those shown in FIG. 1. However, it is preferred that the determining, displaying, and updating steps 102, 104, 106, 108 be performed repetitively, and substantially in parallel.

The method 100 can be advantageous in that production test data and debug test data is separately displayed, making it easier to determine what the data means, identify trends, et cetera. In the case of debug data, there will typically be much less data to review, making it easier to determine what the debug data means.

The method 100 shown in FIG. 1 may be implemented by means of computer-readable code stored on computer-readable media. The computer-readable media may include, for example, any number or mixture of fixed or removable media (such as one or more fixed disks, random access memories (RAMs), read-only memories (ROMs), or compact discs), at either a single location or distributed over a network. The computer readable code will typically comprise software, but could also comprise firmware or a programmed circuit.

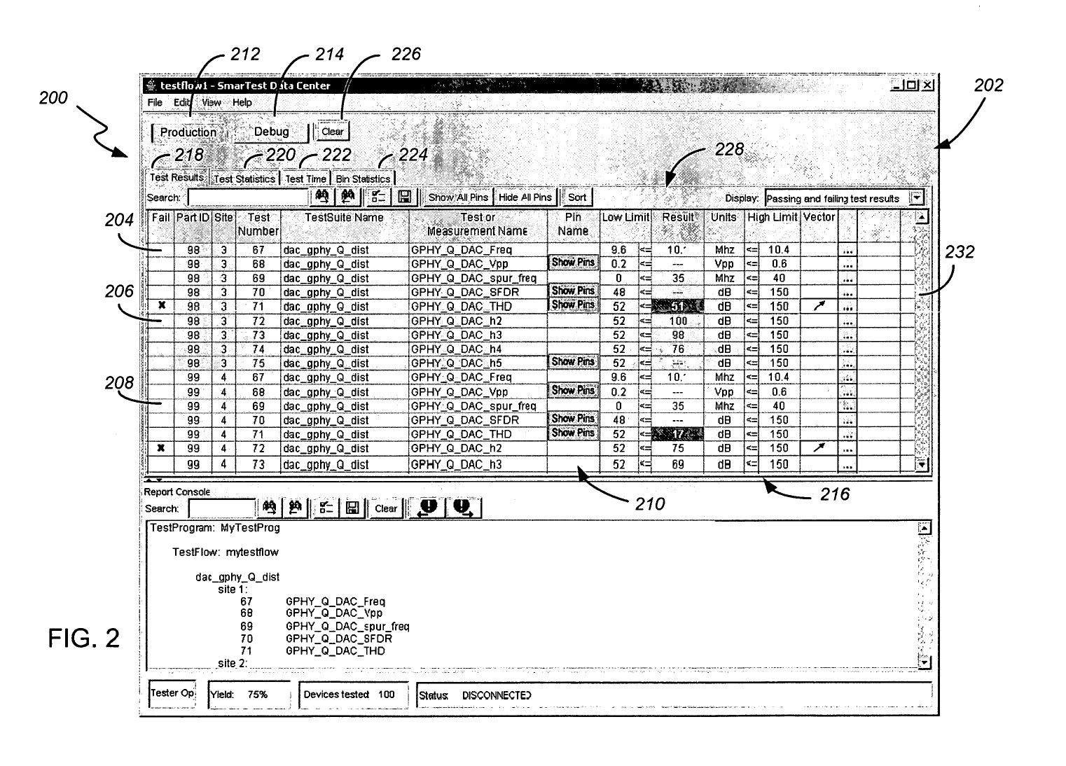

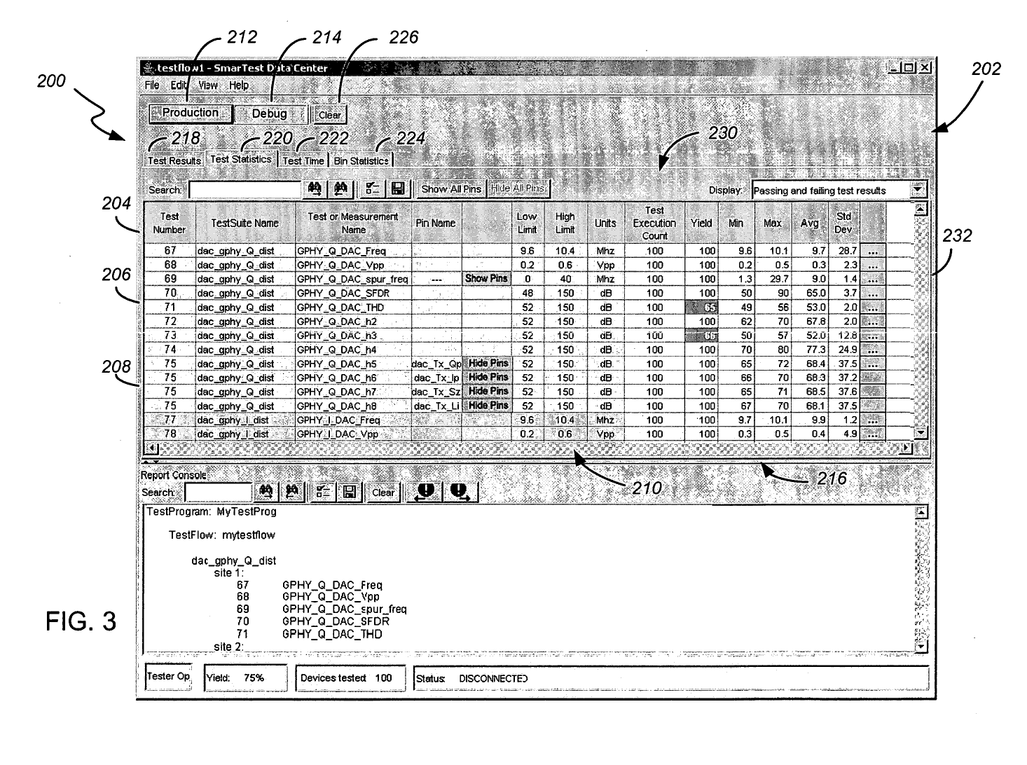

FIG. 2 illustrates an exemplary window (or screen) 202 of a GUI 200 via which the method 100 may be implemented. As shown, a plurality of test data items, such as test data entries 204, 206 and 208, may be displayed via the window 202. By way of example, each test data entry 204, 206, 208 comprises three test result identifiers, including: a “Test Number”, a “Test or Measurement Name”, and a “TestSuite Name” that identifies a test suite to which the test name and number belong. In addition, each test data entry 204, 206, 208 comprises: information identifying the test resources via which a test result was acquired (e.g., a test “Site” number), and information identifying the device and pin for which a test result was acquired (e.g., a device “Part ID”, and a device “Pin Name”). Each test data entry 204, 206, 208 also comprises one or more test results, which may take forms such as a value in a “Result” field and/or a check in a “Fail” field (e.g., for those tests that have failed). For measurement-type test results, “Unit”, “Low Limit” and “High Limit” fields may also be populated.

Preferably, the window 202 is displayed during execution of a plurality of tests on which the test data entries 204, 206, 208 are based (i.e., during test of a device under test). New test results can then be displayed via the window as they are acquired, and a user can be provided a “real-time” display of test results. Alternately, device testing can be completed, and a log of test results can be saved to volatile or non-volatile storage (e.g., memory or a hard disk). The test results can then be read and displayed in succession via the window 202 (i.e., not in real-time). Typically, the test data entries 204, 206, 208 that are displayed at any one time represent only some of the test data entries or items that are generated during execution of a plurality of tests. One or more mechanisms such as a scroll bar 232 may be provided to allow a user to navigate to different test data entries or items.

By way of example, FIG. 2 illustrates a display of production test data 228 (i.e., a display in which the test data entries 204, 206, 208 pertain to production test data). A graphical button 212 labeled “Production” is associated with the production display 228 and serves as both a production mode identifier and production mode selector. Similarly, a graphical button 214 labeled “Debug” is associated with a display of debug test data 230 (FIG. 3) and serves as both a debug mode identifier and selector. In one embodiment of the GUI 200, the buttons 212, 214 are displayed via the window 202 at all times.

As a result of FIG. 2 illustrating a display of production test data 228, the “Production” button 212 is shown depressed, and the “Debug” button 214 is shown un-depressed. If a user graphically clicks on the “Debug” button 214, the window 202 may be updated to show the “Debug” button 214 depressed and the “Production” button 212 un-depressed (see, FIG. 3). In addition, the GUI 200 may be updated to focus on a display of debug test data 230. When the GUI 200 is updated, the test data entries 204, 206, 208 shown in the common fill area 216 may be replaced with test data entries pertaining to a debug mode. Alternately, the production display 228 and debug display 230 could comprise respective and different windows of the GUI 200, and an update of the GUI 200 to focus on the production display 228 or the debug display 230 could result in a pertinent one of the windows being launched and/or brought to the front of the GUI (i.e., overlaid over the other window).

Although the “Production” and “Debug” buttons 212, 214 are shown in FIG. 2 to serve as both mode identifiers and mode selectors, their identifying and selecting functions could alternately be provided via separate sets of buttons. Or, the buttons 212, 214 could be replaced or supplemented by, for example: graphical tabs, check boxes, pull-down menu selections, pop-up menu selections, graphical toolbar icons, or dialog box options. The buttons 212, 214 could also take the form of a single mechanism, such as a button, that is dynamically reconfigured to allow a user to select whichever mode is not currently selected (i.e., production or debug).

Also, in addition to (or instead of) one of the buttons 212, 214 being shown depressed to indicate which of the production display 228 or debug display 230 is currently displayed, the buttons 212, 214 or other identification/selection mechanisms could be distinguished in other ways, such as by use of contrasting colors, highlighting or bolded text labels.

In addition to providing graphical buttons 212, 214 for selecting the production mode or the debug mode, the GUI 200 provides a plurality of graphical tabs 218, 220, 222, 224 labeled “Test Results”, “Test Statistics”, “Test Time” and “Bin Statistics”. These tabs 218, 220, 222, 224 are subservient to the mode selector buttons 212, 214, such that selection of one of the mode selector buttons 212, 214 results in the tabs 218, 220, 222, 224 being alternately configured to access production test data or debug test data. Similarly, test data items pertaining to 1) the production mode or the debug mode, and 2) one of the tabs 218, 220, 222 or 224, are swapped into the common fill area 216. Thus, for example, selection of the “Test Statistics” tab 220 while the “Debug” button 212 is depressed would result in test statistics pertaining to the debug mode being displayed in the common fill area 216, as shown in FIG. 3. That is, test statistics based solely on debug data would be displayed in the common fill area 216.

The precise format and content of the data which is displayed after user selection of one of the tabs 220, 222 or 224 is beyond the scope of this disclosure.

As further shown in FIG. 2, each of the test data entries 204, 206, 208 may be displayed as a line of a table 210, with different lines of the table corresponding to different ones of the test data entries 204, 206, 208. For purposes of this description, a “table” is defined to be either an integrated structure wherein data is displayed in tabular form, or multiple structures that, when displayed side-by-side, enable a user to review information in rows and columns.

Similarly to the mode selector buttons 212, 214, the tabs 218, 220, 222 and 224 could also be implemented in other ways. For example, the tabs 218, 220, 222 and 224 could be implemented via any or all of: graphical buttons, check boxes, pull-down menu selections, pop-up menu selections, graphical toolbar icons, or dialog box options.

The window 202 further displays a “Clear” button 226. The “Clear” button 226 is configured to clear test data for whichever mode (production or debug) is currently selected. In some cases, the “Clear” button 226 may be configured to only clear data that corresponds to a currently selected one of the tabs 218, 220, 222 or 224. Alternately, the “Clear” button 226 could be configured to clear all production data or all debug data, depending on which mode has been selected via the buttons 212 and 214. Of note, all of the configurations mentioned in this paragraph may be performed “in the background”, by computer-readable code that supports the GUI 200. Alternately, the configurations could be performed as part of an application setup or configuration routine.

Instead of a “Clear” button 226, a user-selectable mechanism for separately clearing at least a portion of 1) production test data, or 2) debug test data, could be implemented in other ways. For example, the mechanism could be implemented via any or all of: one or more graphical buttons, check boxes, pull-down menu selections, pop-up menu selections, graphical toolbar icons, or dialog box options.

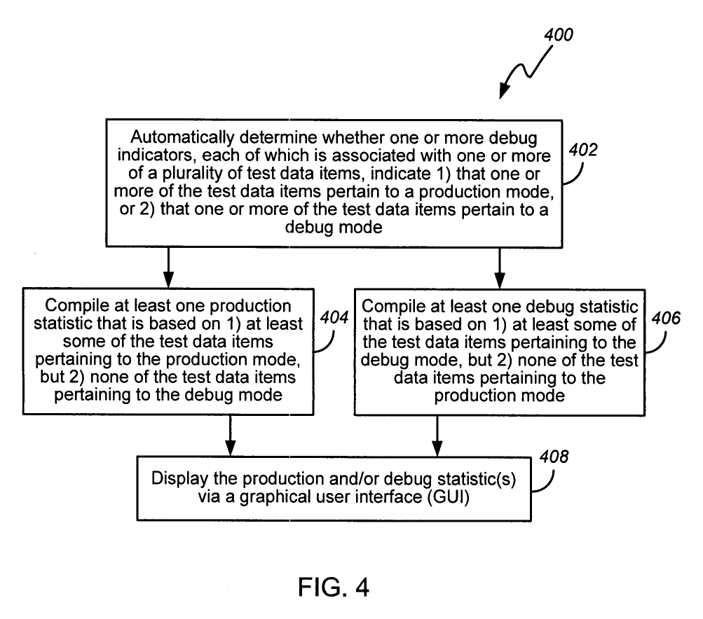

In accord with a second exemplary embodiment of the invention, FIG. 4 illustrates another computer-implemented method 400 that operates on a plurality of test data items and one or more debug indicators. As with the method 100 (FIG. 1), the method 400 presumes that each of the debug indicators is associated with one or more of the plurality of test data items.

The method 400 begins with a computer automatically determining whether one or more of the afore-mentioned debug indicators indicate 1) that one or more of the test data items pertain to a production mode, or 2) that one or more of the test data items pertain to a debug mode. See, block 402. At least one production statistic is then compiled based on 1) at least some of the test data items pertaining to the production mode, but 2) none of the test data items pertaining to the debug mode. See, block 404. Optionally, at least one debug statistic may also be compiled, based on 1) at least some of the test data items pertaining to the debug mode, but 2) none of the test data items pertaining to the production mode. See, block 406. The production and/or debug statistic(s) may then be displayed via a GUI. See, block 408.

The method 400 can be advantageous because it does not skew production statistics with debug test data, and vice versa.

In one embodiment of the method 400, either one or more of the production statistics, or one or more of the debug statistics, are alternately displayed. This may be accomplished via the GUI 200 (FIGS. 2 & 3), by means of the “Test Statistics” tab 222 being subservient to the mode selector buttons 212, 214, such that the “Test Statistics” tab is alternately configured to access production statistics or debug statistics.

The method 400 may also comprise providing, via the GUI, one or more user-selectable mechanisms for separately clearing 1) one or more of the production statistics, or 2) one or more of the debug statistics. In the GUI 200 (FIG. 2), this functionality is provided by means of the “Clear” button 226, which may be alternately configured as already described.

Similarly to the method 100, the method 400 may be implemented by means of computer-readable code stored on computer-readable media.

What is claimed is:

1. A computer-implemented method, comprising:
automatically determining whether one or more debug indicators, each of which is associated with one or more of a plurality of test data items, indicate 1) that one or more of the test data items pertain to a production mode, or 2) that one or more of the test data items pertain to a debug mode;
displaying at least one mode selector via a graphical user interface (GUI), the at least one mode selector providing a graphical mechanism via which a user can select the production mode or the debug mode;
upon the user selecting the production mode, updating the GUI to focus on a display of production test data, wherein the production test data includes at least some of the test data items that pertain to the production mode, but none of the test data items that pertain to the debug mode; and
upon the user selecting the debug mode, updating the GUI to focus on a display of debug test data, wherein the debug test data includes at least some of the test data items that pertain to the debug mode, but none of the test data items that pertain to the production mode.

2. The method of claim 1, wherein one or more of the debug indicators comprise tags associated with individual ones of the test data items.

3. The method of claim 1, wherein the plurality of test data items have a sequential order, and wherein one or more of the debug indicators comprise contextual information that is interspersed with the sequential order of the test data items.

4. The method of claim 1, wherein said determining, displaying, and updating steps are performed repetitively, and substantially in parallel.

5. The method of claim 1, wherein updating the GUI to focus on the display of the production test data or the display of the debug data comprises:
alternately swapping into a common fill area of the GUI either 1) at least some of the production test data, or 2) at least some of the debug test data.

6. The method of claim 5, further comprising:
respectively associating the display of production test data and the display of debug test data with a production mode identifier and a debug mode identifier;
displaying the production mode identifier and the debug mode identifier via the GUI; and
distinguishing the production mode identifier from the debug mode identifier, to indicate whether the GUI has been updated to focus on the display of production test data or the display of debug test data.

7. The method of claim 6, wherein the at least one mode selector includes the production mode identifier and the debug mode identifier.

8. The method of claim 1, wherein the at least one mode selector comprises a production mode selector and a debug mode selector.

9. The method of claim 1, wherein:
updating the GUI to focus on the display of production test data comprises configuring a set of graphical tabs to access items of the production test data; and
updating the GUI to focus on the display of debug test data comprises configuring the set of graphical tabs to access items of the debug test data.

10. The method of claim 1, further comprising:
providing, via the GUI, one or more user-selectable mechanisms for separately clearing 1) at least a portion of the production test data, or 2) at least a portion of the debug test data.

11. A computer-implemented method, comprising:
automatically determining whether one or more debug indicators, each of which is associated with one or more of a plurality of test data items, indicate 1) that one or more of the test data items pertain to a production mode, or 2) that one or more of the test data items pertain to a debug mode;
compiling at least one production statistic that is based on 1) at least some of the test data items pertaining to the production mode, but 2) none of the test data items pertaining to the debug mode; and
displaying the at least one production statistic via a graphical user interface (GUI).

12. The method of claim 11, further comprising:
compiling at least one debug statistic that is based on at least some of the test data items pertaining to the debug mode, but none of the test data items pertaining to the production mode; and
displaying the at least one debug statistic via the GUI.

13. The method of claim 12, further comprising, alternately displaying either 1) one or more of the production statistics, or 2) one or more of the debug statistics.

14. The method of claim 12, further comprising:
providing, via the GUI, one or more user-selectable mechanisms for separately clearing 1) one or more of the at least one production statistic, or 2) one or more of the at least one debug statistic.

15. Apparatus, comprising:
computer-readable media;
computer-readable code, stored on the computer-readable media, including,
code to cause a computer to automatically determine whether one or more debug indicators, each of which is associated with one or more of a plurality of test data items, indicate 1) that one or more of the test data items pertain to a production mode, or 2) that one or more of the test data items pertain to a debug mode;
code to cause the computer to display at least one mode selector via a graphical user interface (GUI), the at least one mode selector providing a graphical mechanism via which a user can select the production mode or the debug mode;
code to, upon the user selecting the production mode, cause the computer to update the GUI to focus on a display of production test data, wherein the production test data includes at least some of the test data items that pertain to the production mode, but none of the test data items that pertain to the debug mode; and
code to, upon the user selecting the debug mode, cause the computer to update the GUI to focus on a display of debug test data, wherein the debug test data includes at least some of the test data items that pertain to the debug mode, but none of the test data items that pertain to the production mode.

16. The apparatus of claim 15, wherein the one or more debug indicators comprise tags associated with individual ones of the test data items.

17. The apparatus of claim 15, wherein the plurality of test data items have a sequential order, and wherein one or more of the debug indicators comprise contextual information that is interspersed with the sequential order of the test data items.

18. The apparatus of claim 15, wherein the code to cause the computer to update the GUI to focus on the display of the production test data or the display of the debug data comprises:
code to alternately swap either 1) at least some of the production test data, or 2) at least some of the debug test data, into a common fill area of the GUI.

19. The apparatus of claim 18, further comprising:
code to respectively associate the display of production test data and the display of debug test data with a production mode identifier and a debug mode identifier;
code to cause the computer to display the production mode identifier and the debug mode identifier via the GUI; and
code to cause the computer to distinguish the production mode identifier from the debug mode identifier, to indicate whether the GUI has been updated to focus on the display of production test data or the display of debug test data.

20. The apparatus of claim 19, wherein the at least one mode selector includes the production mode identifier and the debug mode identifier.

21. The apparatus of claim 15, wherein the at least one mode selector comprises a production mode selector and a debug mode selector.

22. The apparatus of claim 21, wherein the production and debug mode selectors comprise respective graphical buttons.

23. The apparatus of claim 15, wherein:
the code to cause the computer to update the GUI to focus on the display of production test data comprises code to configure a set of graphical tabs to access items of the production test data; and
the code to cause the computer to update the GUI to focus on the display of debug test data comprises code to configure the set of graphical tabs to access items of the debug test data.

24. The apparatus of claim 15, wherein the test data items comprise test data entries, and wherein each test data entry includes at least a test result identifier and a corresponding test result.

25. The apparatus of claim 15, further comprising:
code to cause the computer to provide, via the GUI, one or more user-selectable mechanisms for separately clearing 1) at least a portion of the production test data, or 2) at least a portion of the debug test data.

26. Apparatus, comprising:
computer-readable media;
computer-readable code, stored on the computer-readable media, including,
code to cause a computer to automatically determine whether one or more debug indicators, each of which is associated with one or more of a plurality of test data items, indicate 1) that one or more of the test data items pertain to a production mode, or 2) that one or more of the test data items pertain to a debug mode;
code to cause the computer to compile at least one production statistic that is based on at least some of the test data items pertaining to the production mode, but none of the test data items pertaining to the debug mode; and
code to cause the computer to display the at least one production statistic via a graphical user interface (GUI).

27. The apparatus of claim 26, further comprising:
code to cause the computer to compile at least one debug statistic that is based on at least some of the test data items pertaining to the debug mode, but none of the test data items pertaining to the production mode; and
code to cause the computer to display the at least one debug statistic via the GUI.

28. The apparatus of claim 27, further comprising, code to cause the computer to alternately display either 1) one or more of the production statistics, or 2) one or more of the debug statistics.

29. The apparatus of claim 27, further comprising:
code to cause the computer to provide, via the GUI, one or more user-selectable mechanisms for separately clearing 1) one or more of the at least one production statistic, or 2) one or more of the at least one debug statistic.
